(19) United States
(12) Patent Application Publication
(10) Pub. No.: US 2026/0065126 A1
(43) Pub. Date: Mar. 5, 2026

(54) DISTRIBUTED MACHINE LEARNING TRAINING AND INFERENCE USING MICRO-PROCESSING GROUPS

(71) Applicant: Cisco Technology, Inc., San Jose, CA (US)

(72) Inventors: Myungjin Lee, Bellevue, WA (US); Pranav Umesh Gadikar, Jersey City, NJ (US); Akshay Jajoo, San Jose, CA (US); Charles Fleming, Oxford, MS (US); Ramana Rao V.R. Kompella, Foster City, CA (US)

(73) Assignee: Cisco Technology, Inc., San Jose, CA (US)

(21) Appl. No.: 18/817,474

(22) Filed: Aug. 28, 2024

(51) Int. Cl. G06N 20/00

(52) U.S. Cl. CPC G06N 20/00

(57) ABSTRACT

In one implementation, a device maintains a set of processing groups of which the device is a member in a distributed machine learning system. The device performs a machine learning task with respect to a portion of a machine learning model distributed across the distributed machine learning system. The device receives an indication of a change in the distributed machine learning system. The device adjusts, based on the indication, the set of processing groups of which the device is a member in the distributed machine learning system.

### TECHNICAL FIELD

The present disclosure relates generally to distributed machine learning training and inference using micro-processing groups.

### BACKGROUND

In recent years, machine learning has expanded in its capabilities and is now being used across a wide range of industries and use cases. For instance, machine learning may be used for purposes of controlling a system, analyzing images or video data, interfacing with users, and the like. Coupled with this increase in capabilities, though, is also an increase in the amount of computing resources needed to train many machine learning models and to execute them to make inferences. To this end, recent efforts within the field of machine learning have focused on distributed computing systems for purposes of model training and inference.

However, current platforms for distributed machine learning take an all-or-nothing approach with respect to a given training or inference task. In other words, if an issue arises during performance of the task, such as one of the computational nodes encountering an error, the task itself will fail. In these instances, the operator is left with no option other than to fix the issue and restart the task. This may be tolerated for a training task as the training time can last over days, weeks, or even longer where the time to reconfigure the distributed system is comparatively small (e.g., on the order of minutes, in many cases). For inference tasks, though, this additional time to reconfigure the system can increase the total amount of time to inference by a large margin, leading to poor performance and low user satisfaction.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example architecture for distributed machine learning training and inference;

FIG. 4 illustrates an example architecture for distributed machine learning training and inference using micro-processing groups;

FIG. 5 illustrates an example of a distributed node executing a micro-group manager;

FIGS. 6A-6B illustrates an example of a failure of a distributed node;

FIGS. 7A-7B illustrate an example of adding a node to a distributed machine learning training and inference system; and

FIG. 8 illustrates an example simplified procedure for distributed machine learning training and inference using micro-processing groups.

### DESCRIPTION OF EXAMPLE IMPLEMENTATIONS

### Overview

According to one or more implementations of the disclosure, a device maintains a set of processing groups of which the device is a member in a distributed machine learning system. The device performs a machine learning task with respect to a portion of a machine learning model distributed across the distributed machine learning system. The device receives an indication of a change in the distributed machine learning system. The device adjusts, based on the indication, the set of processing groups of which the device is a member in the distributed machine learning system.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

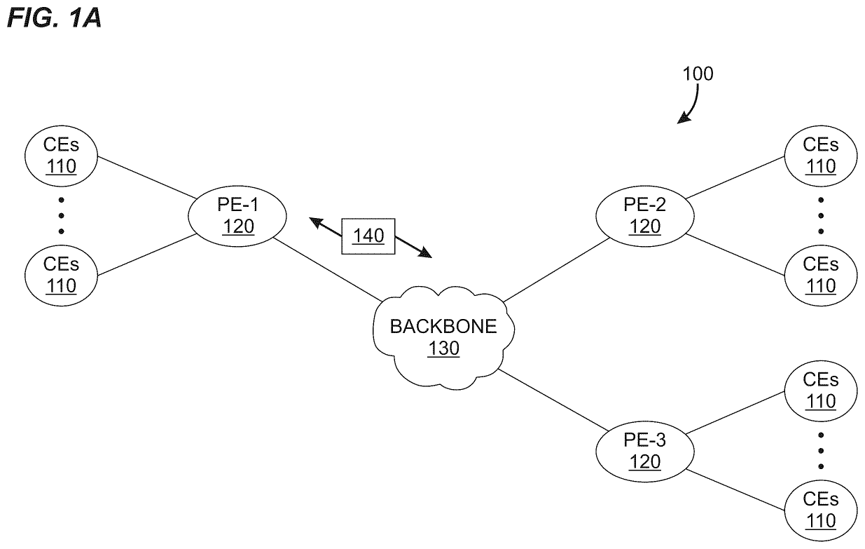

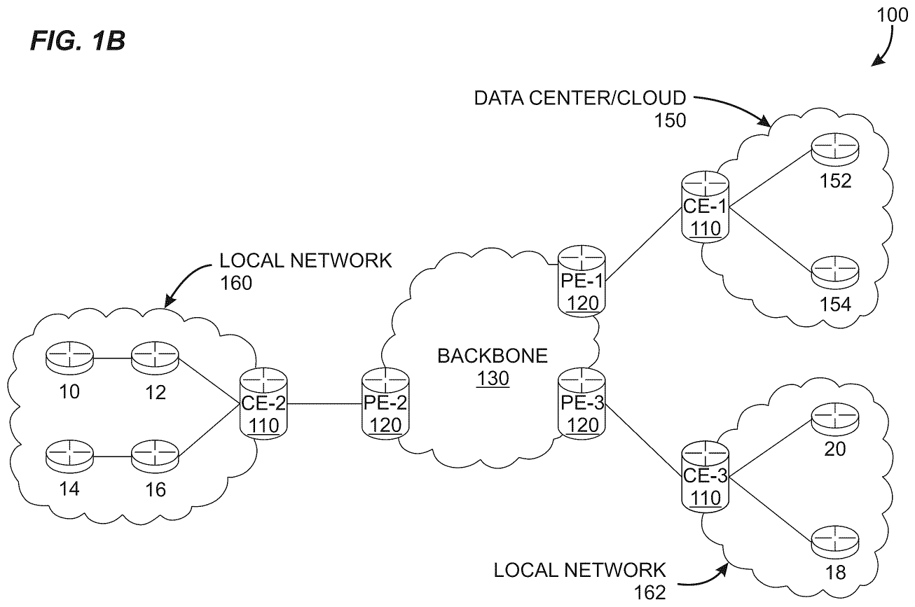

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

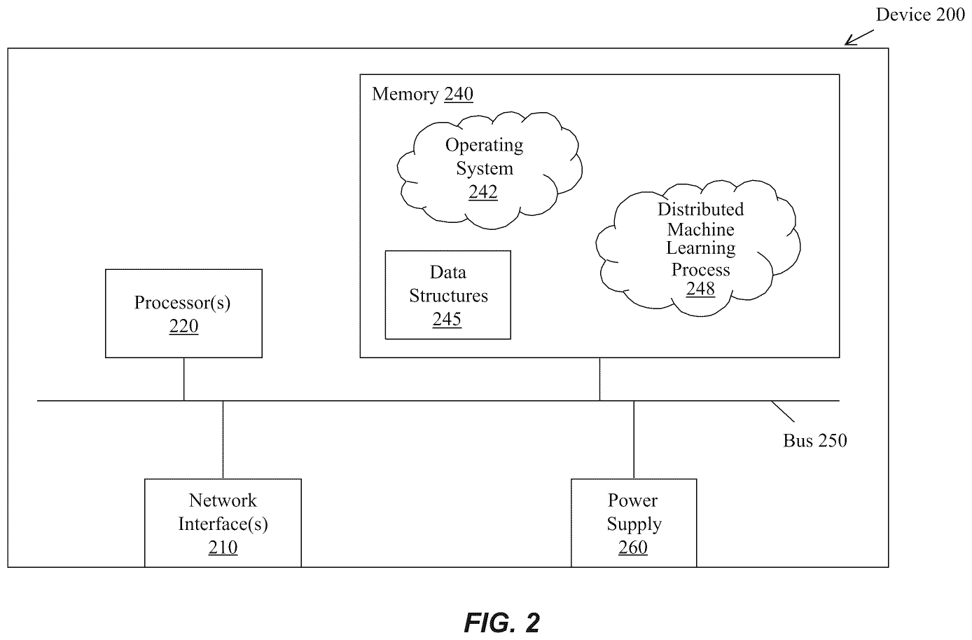

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250 and powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise an artificial intelligence (AI) process such as distributed machine learning process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, distributed machine learning process 248 may include computer executable instructions that, when executed by processor(s) 220, cause device 200 to perform the techniques described herein. To do so, in some implementations, distributed machine learning process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, distributed machine learning process 248 may employ one or more supervised, unsupervised, or semi-supervised machine learning models. Generally, supervised learning entails the use of a training set of data, as noted above, that is used to train the model to apply labels to the input data. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that distributed machine learning process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, distributed machine learning process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

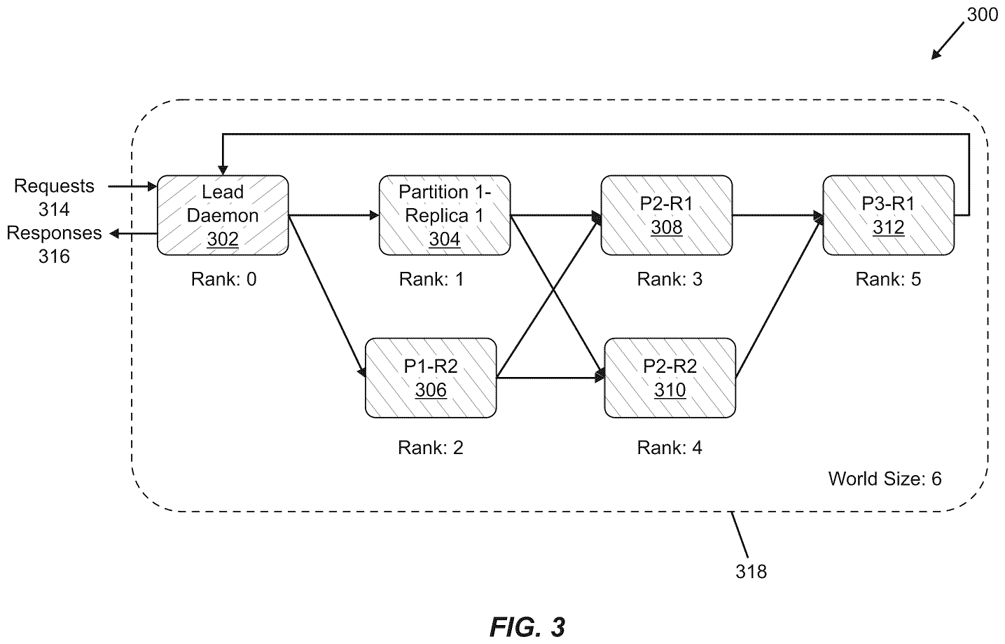

As noted above, machine learning/artificial intelligence training and serving is rapidly moving towards using distributed architectures whereby a training or inference/serving task is performed across a plurality of computing nodes. FIG. 3 illustrates an example architecture 300 for distributed machine learning training and inference, in some instances.

As shown, architecture 300 includes a plurality of computing nodes, each of which is responsible for training or executing a different partition of the machine learning model. More specifically, six computing nodes are shown as part of architecture 300: node 302, node 304, node 306, node 308, node 310, and node 312. It should be appreciated that the number of computing nodes can vary depending on the task and that the nodes shown are for illustrative purposes only. It should also be appreciated that each such node may take the form of a separate device or, alternatively, discrete processes executed across any number of underlying devices.

One potential way to perform a training or inference task is to assign roles to each of the nodes in architecture 300. For instance, node 302 may be designated as the lead daemon that is responsible for receiving requests 314 and returning responses 316, such as to a user interface or other control service. Similarly, the other nodes may also be assigned tasks such as training or executing different partitions of the machine learning model. For instance, node 304 may be responsible for executing or training a first partition of the model, node 306 may be responsible for executing or training a second partition (P2) of the model, and node 312 may be responsible for executing or training a third partition (P3).

In some instances, some of the nodes in architecture 300 may also be tasked with executing replicas of the partitions of the machine learning model. For instance, node 304 may be assigned a first replica of the first partition of the model and node 306 may be assigned a second replica of that same partition (denoted P1-R2). Similarly, node 308 may be assigned a first replica of the second partition (denoted P2-R1) and node 310 may be assigned a second replica of that partition (denoted P2-R2). The use of replica partitions allows for greater throughput as doing so allows for load balancing.

For example, consider the case in which requests 314 includes an inference request. In such a case, node 302 may opt to send that request onward to node 304 which uses its partition on the input data and forwards its results on to node 308. Node 308 then uses its own partition (P2) on those results and then sends the results on to node 312. Node 312 then uses its own partition (P3) and returns the final response to node 302. Node 302 then relays the final response to the requester as part of responses 316 shown.

Typically, each node in a distributed machine learning system is assigned a rank, which serves as a unique identifier for that node. For instance, node 302 may be assigned rank 0, node 304 may be assigned rank 1, node 306 may be assigned rank 2, etc.

In addition, each node is also assigned to a singular processing group, which is sometimes referred to as a ‘world’ within the art. As shown, for example, processing group 318 may include nodes 302-312 and have a world size of ‘6.’ At the initialization of machine learning task (e.g., training or serving/inference), all nodes must join the process group (i.e., world) and the world size is fixed. Therefore, no new workers can join and the failure of one node may lead to the failure of the job.

In case of a failure, a separate recovery process (e.g., reconstructing/reconfiguring the world with remaining workers) is inevitable. This may be tolerated in the case of training as the training time can be considerably larger than that of the reconfiguration time (e.g., on the order of days or even weeks vs. minutes). However, for inference tasks, this inflexibility may lead to a service level objective (SLO) violation, leading to poor performance and/or user experience (e.g., a user has to wait many minutes for an inference answer). Indeed, current communication backends such as Message Passing Interface (MPI), GLOO, NCCL, and the like, which allow for distributing tasks in PyTorch, TensorFlow, and the like, often exhibit such SLO violations due to their monolithic approach to their processing groups.

### Distributed Machine Learning Training and Inference Using Micro-Processing Groups

The techniques herein introduce the concept of micro-processing groups (e.g., “micro-worlds”) within a machine learning system that performs training and/or inference in a distributed manner. As described below, doing so allows for nodes to be removed dynamically from the system, without the need for the training or inference task to stop until the system can be reconfigured. In addition, the techniques herein also allow for the addition of new nodes during performance of a training or inference task, Illustratively, the techniques described herein may be performed by hardware, software, and/or firmware, such as in accordance with distributed machine learning process 248, which may include computer executable instructions executed by the processor 220 (or independent processor of interfaces 210) to perform functions relating to the techniques described herein.

Specifically, according to various embodiments, a device maintains a set of processing groups of which the device is a member in a distributed machine learning system. The device performs a machine learning task with respect to a portion of a machine learning model distributed across the distributed machine learning system. The device receives an indication of a change in the distributed machine learning system. The device adjusts, based on the indication, the set of processing groups of which the device is a member in the distributed machine learning system.

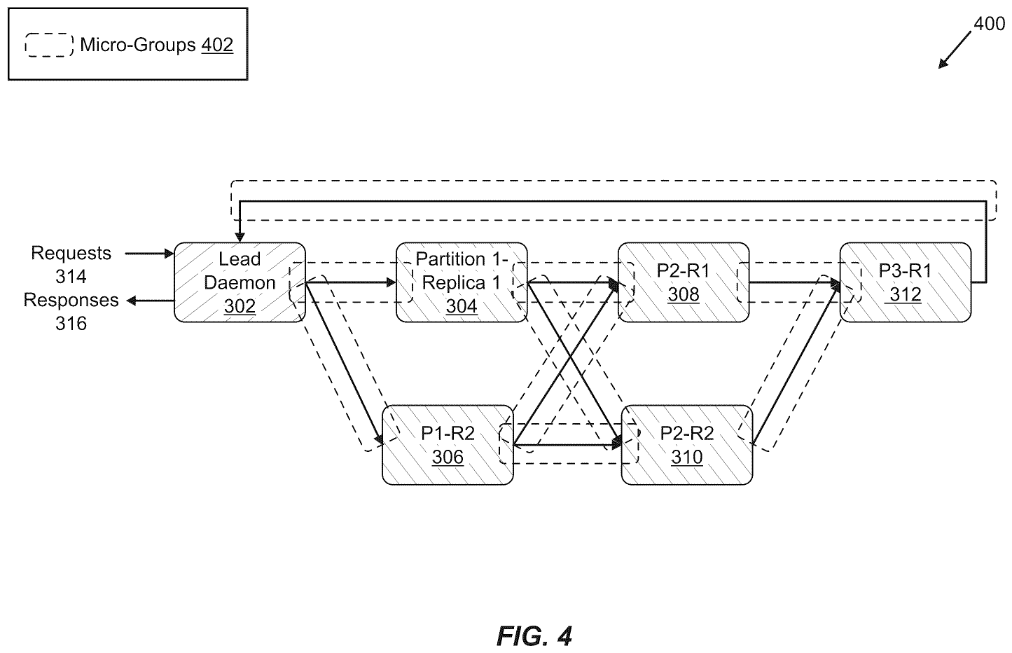

Operationally, FIG. 4 illustrates an example architecture 400 for distributed machine learning training and inference using micro-processing groups, in various implementations. Continuing the example of FIG. 3, again assume that there are nodes 302-312, each having an assigned role (e.g., node 302 functions as a lead daemon, node 304 is responsible for the first replica of the first partition of the model, etc.).

In various implementations, rather than using a singular processing group 318 as in FIG. 3, architecture 400 is instead implemented using micro-groups 402 (e.g., “micro-worlds). Typically, each micro-group 402 includes two members, with one of the members being designated the “leader” of the micro-group. Such a designation may be denoted, for instance, by the assigned ranks of the nodes in the micro-group (e.g., the rank 0 member is the ‘leader’and the rank 1 member is the other/downstream member).

Thus, in architecture 400, there may be a total of nine micro-groups 402, instead of a singular processing group 318:
A micro-group between node 302 and node 304
A micro-group between node 302 and node 306
A micro-group between node 304 and node 308
A micro-group between node 304 and node 310
A micro-group between node 306 and node 308
A micro-group between node 306 and node 310
A micro-group between node 308 and node 312
A micro-group between node 310 and node 312
A micro-group between node 312 and node 302

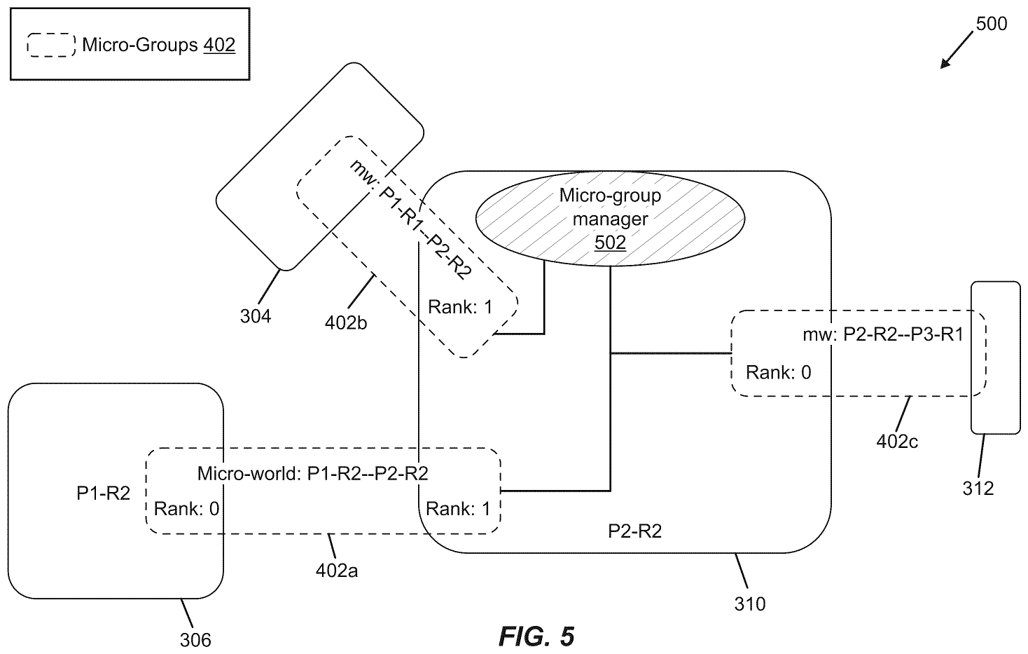

FIG. 5 illustrates an example 500 of how micro-groups 402 are managed in architecture 400, according to various implementations. As shown, consider the case of node 310. In various implementations, each node may execute its own micro-group manager 502 (e.g., through distributed machine learning process 248), which is responsible for maintaining the list/set of its micro-group memberships, as well as communicating with other nodes via their corresponding micro-groups 402. For instance, its own micro-group manager 502 may maintain the following set of plurality of micro-groups 402:
Micro-group/world 402a whose members are node 306 and node 310, with node 306 being designated the ‘leader’ by having rank 0 and node 310 being assigned rank 1 as the downstream node.
Micro-group/world 402b whose members are node 304 and node 310, with node 304 being designated the leader by having rank 0 and node 310 being assigned rank 1 as the downstream node.
Micro-group/world 402c whose members are node 310 and node 312, with node 310 being designated the leader by having rank 0 and node 312 being assigned rank 1 as the downstream node.

During execution, micro-group manager 502 is responsible for receiving requests via any of its maintained micro-groups 402 and routing requests sent by node 310 via any of its maintained micro-groups 402. For instance, micro-group manager 502 may receive a request to perform training or inferencing via the communication channel of micro-group/world 402a from node 306. In turn, node 310 may process this request (e.g., by performing training or, alternatively, performing inferencing using its model partition), thereby generating results. Micro-group manager 502 then selects the next downstream node from among its registered micro-worlds and sends the results onward to the next node. For instance, after node 310 performs inference on the request from node 306 via micro-group/world 402a, micro-group manager 502 may send a new request that includes those results on to node 312 via the communication channel of micro-group/world 402c.

The other nodes in the system may operate in a similar manner as that of node 310 through execution of their own micro-group managers. By using multiple, small processing groups rather than a singular processing group, the full system is able to adjust itself dynamically, even when there is a task (e.g., training or inference) being processed (e.g., as smaller tasks distributed across its nodes).

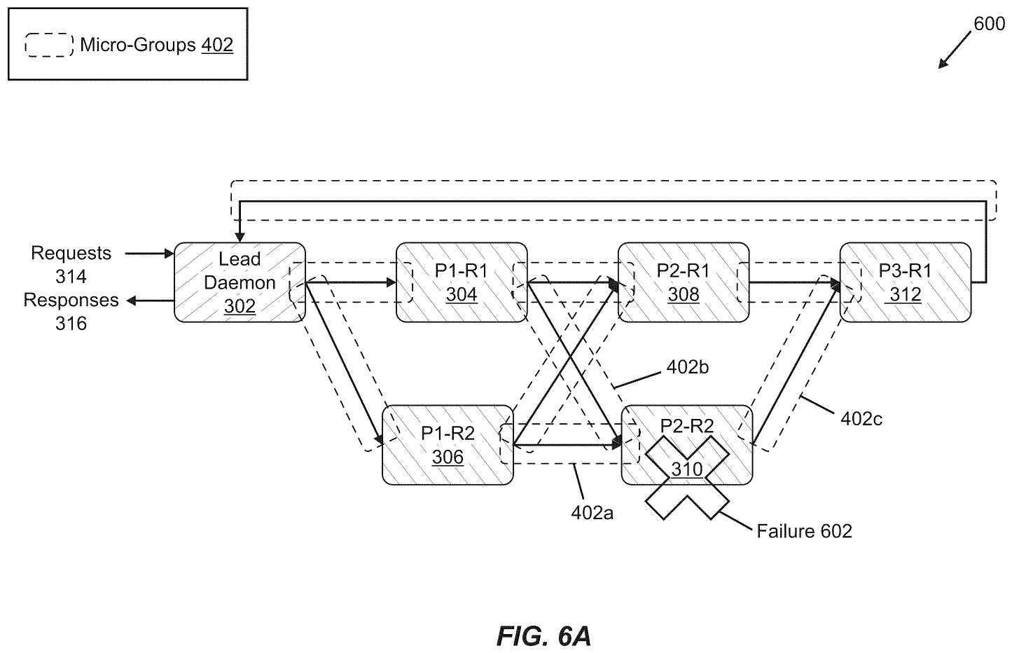

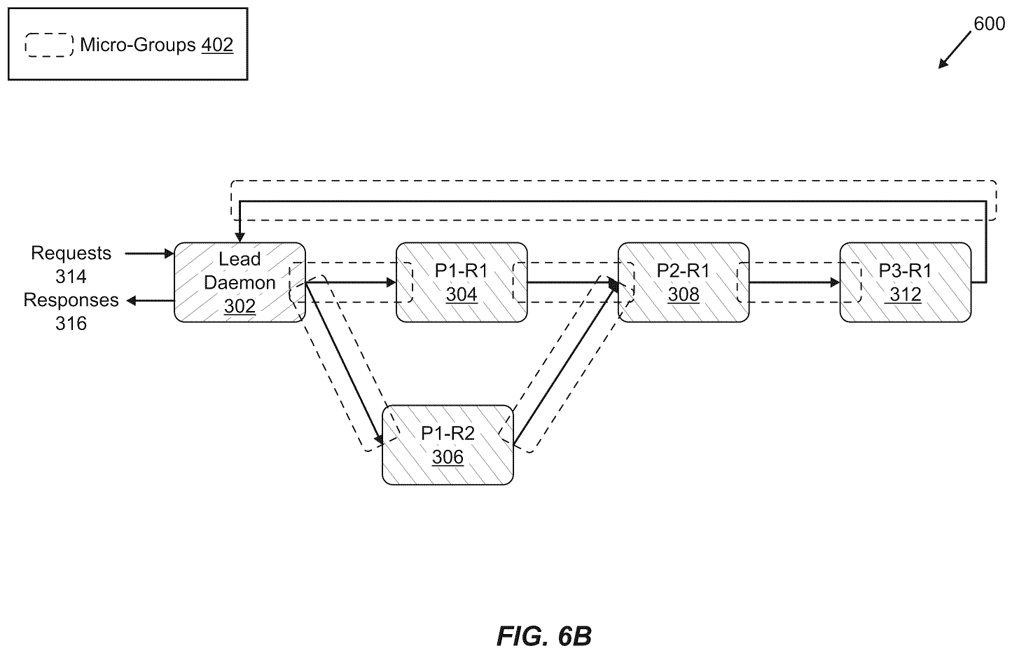

FIGS. 6A-6B illustrates an example 600 of a failure of a distributed node, in various implementations. As shown in FIG. 6A, assume now that nodes 302-312 have been configured in accordance with FIGS. 4-5, with each belonging to multiple micro-groups 402, and that node 310 experiences a failure 602. Such a failure may be internal to node 310 itself or a communication failure making node 310 unreachable. In cases in which a singular processing group is used across the entire set of nodes, this would typically require reconfiguration of the processing group/world, to restart the task.

However, as shown in FIG. 6B, the system may respond to failure 602 by simply having the micro-group managers of node 304, node 306, and node 312 remove their micro-groups/worlds of which they are members with node 310. Detection of node 310 can be achieved in a number of ways, according to various implementations. For instance, in some cases, each node may send out heartbeat communications via their associated micro-groups/worlds, to ensure that the opposing node is still reachable and active. If not, the sending node may remove that micro-group/world from its active set.

In other implementations, the nodes may request confirmation receipt of any communications that they send and, if no confirmation is returned, remove that micro-group/world from its active list. For instance, if node 304 were to send a request to node 310 and not receive a confirmation, it may assume that node 310 has experienced a failure (i.e., failure 602) and remove the micro-group/world comprising node 304 and node 310 from its active list. In turn, node 304 may then send the request to node 308, allowing the system to adapt to node 310 and continue to complete the task requested by requests 314.

In further implementations, the nodes may interface with a controller that is responsible for detecting and reporting failures, such as failure 602. Such a controller may rely on mechanism such as path probing, a heartbeat mechanism, or the like, to detect failures. In turn, the controller may notify the affected nodes that share micro-groups/worlds with the failed node.

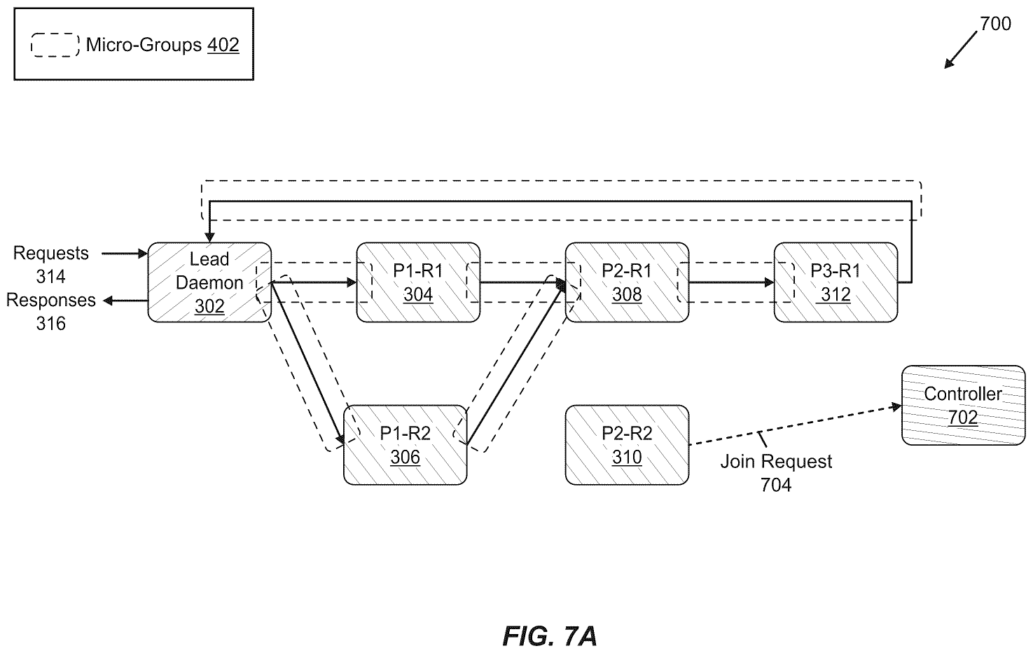

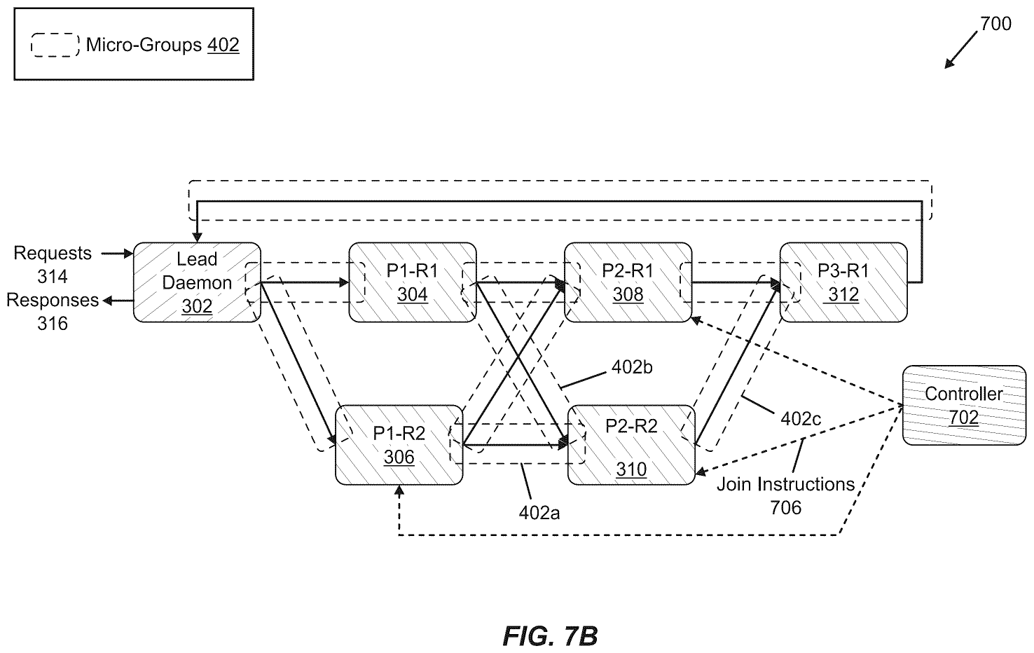

Another potential benefit of the use of micro-groups/worlds is the ability for the distributed system to scale as needed, without having to stop the current task. FIGS. 7A-7B illustrate an example 700 of adding a node to a distributed machine learning training and inference system, in various implementations. Continuing the prior examples in FIGS. 4-6B, assume now that node 310 has come back online and needs to rejoin the distributed system. In such a case, as shown in FIG. 7A, node 310 may send a join request 704 to a controller 702 responsible for overseeing the operation of the distributed system. Node 310 may likewise send join request 704 when first coming online and not previously a member of the distributed system.

As shown in FIG. 7B, controller 702 may then send join instructions 706 to the relevant nodes, such as node 306, node 308, and node 310 itself, to form or re-enable the micro-groups/worlds 402a-402c described previously in FIG. 5. For instance, controller 702 may send join instructions 706 to each of their micro-group managers, instructing them to add micro-groups/worlds 402a-402c to their active sets of micro-groups/worlds. In doing so, node 310 is dynamically added to the distributed system and becomes eligible to receive requests from node 304 and node 306, as well as to send requests to node 312.

In further implementations, controller 702 may send join instructions 706 for node 310 without first receiving join request 704 from it. For instance, if controller 702 determines that node 308 is close to being overloaded, it may configure node 310 to execute a replica of the second partition of the machine learning model (P2-R2) and send join instructions 706, to add node 310 as an alternate for node 308.

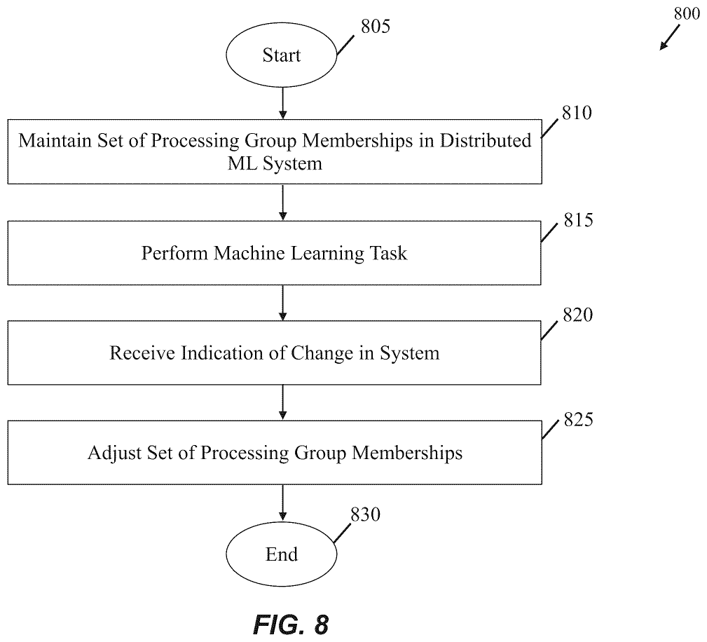

FIG. 8 illustrates an example simplified procedure 800 (e.g., a method) for distributed machine learning training and inference using micro-processing groups, in accordance with one or more implementations described herein. For example, a non-generic, specifically configured device (e.g., device 200), such as a router, firewall, controller for a network, endpoint, server, or the like, may perform procedure 800 by executing stored instructions (e.g., distributed machine learning process 248). The procedure 800 may start at step 805, and continues to step 810, where, as described in greater detail above, the device may maintain a set of processing groups of which the apparatus is a member in a distributed machine learning system. In various implementations, each of the set of processing groups assigns a rank to the device indicative of whether the device is downstream or upstream of another member of that processing group. In some implementations, each of the set of processing groups of which the device is a member comprises the device and another node in the distributed machine learning system. In one implementation, the distributed machine learning system comprises a computer network.

At step 815, as detailed above, the device may perform a machine learning task with respect to a portion of a machine learning model distributed across the distributed machine learning system. In some implementations, the machine learning task comprises training the portion of the machine learning model. In other implementations, the machine learning task comprises making an inference using the portion of the machine learning model. In various implementations, the device may perform the machine learning task by receiving input data via a first one of the set of processing groups, using the input data in conjunction with the portion of the machine learning model to generate output data, and sending the output data via a second one of the set of processing groups.

At step 820, the device may receive an indication of a change in the distributed machine learning system, as described in greater detail above. In some instances, the indication of change indicates a failure associated with a particular node in the distributed machine learning system. In further instances, the indication of the change in the distributed machine learning system indicates a node being added to the distributed machine learning system.

At step 825, as detailed above, the device may adjust, based on the indication, the set of processing groups of which the apparatus is a member in the distributed machine learning system. In some implementations, the device adjusts the set of processing groups by deactivating a processing group of which the device and the particular node are members in the set of processing groups. In further implementations, the device adjusts the set of processing groups of which the device is a member by adding a processing group to the set of processing groups that includes the device and a node being added to the distributed machine learning system.

Procedure 800 then ends at step 830.

While there have been shown and described illustrative implementations that provide for distributed machine learning training and inference using micro-processing groups, it is to be understood that various other adaptations and modifications may be made within the spirit and scope of the implementations herein. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof.

Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
maintaining, by a device, a set of processing groups of which the device is a member in a distributed machine learning system;
performing, by the device, a machine learning task with respect to a portion of a machine learning model distributed across the distributed machine learning system;
receiving, at the device, an indication of a change in the distributed machine learning system; and
adjusting, by the device and based on the indication, the set of processing groups of which the device is a member in the distributed machine learning system.

2. The method as in claim 1, wherein each of the set of processing groups assigns a rank to the device indicative of whether the device is downstream or upstream of another member of that processing group.

3. The method as in claim 1, wherein the machine learning task comprises training the portion of the machine learning model.

4. The method as in claim 1, wherein the indication of change indicates a failure associated with a particular node in the distributed machine learning system, and wherein the device adjusts the set of processing groups by deactivating a processing group of which the device and the particular node are members in the set of processing groups.

5. The method as in claim 1, wherein each of the set of processing groups of which the device is a member comprises the device and another node in the distributed machine learning system.

6. The method as in claim 1, wherein the indication of the change in the distributed machine learning system indicates a node being added to the distributed machine learning system.

7. The method as in claim 6, wherein the device adjusts the set of processing groups of which the device is a member by adding a processing group to the set of processing groups that includes the device and the node being added to the distributed machine learning system.

8. The method as in claim 1, wherein performing the machine learning task comprises:
receiving input data via a first one of the set of processing groups;
using the input data in conjunction with the portion of the machine learning model to generate output data; and
sending the output data via a second one of the set of processing groups.

9. The method as in claim 1, wherein the machine learning task comprises making an inference using the portion of the machine learning model.

10. The method as in claim 1, wherein the distributed machine learning system comprises a computer network.

11. An apparatus, comprising:
one or more network interfaces to communicate within a local network;
a processor coupled to the one or more network interfaces and configured to execute one or more processes; and
a memory configured to store a process that is executable by the processor, the process when executed configured to:
maintain a set of processing groups of which the apparatus is a member in a distributed machine learning system;
perform a machine learning task with respect to a portion of a machine learning model distributed across the distributed machine learning system;
receive an indication of a change in the distributed machine learning system; and
adjust, based on the indication, the set of processing groups of which the apparatus is a member in the distributed machine learning system.

12. The apparatus as in claim 11, wherein each of the set of processing groups assigns a rank to the apparatus indicative of whether the apparatus is downstream or upstream of another member of that processing group.

13. The apparatus as in claim 11, wherein the machine learning task comprises training the portion of the machine learning model.

14. The apparatus as in claim 11, wherein the indication of change indicates a failure associated with a particular node in the distributed machine learning system, and wherein the apparatus adjusts the set of processing groups by deactivating a processing group of which the apparatus and the particular node are members in the set of processing groups.

15. The apparatus as in claim 11, wherein each of the set of processing groups of which the apparatus is a member comprises the apparatus and another node in the distributed machine learning system.

16. The apparatus as in claim 11, wherein the indication of the change in the distributed machine learning system indicates a node being added to the distributed machine learning system.

17. The apparatus as in claim 16, wherein the apparatus adjusts the set of processing groups of which the apparatus is a member by adding a processing group to the set of processing groups that includes the apparatus and the node being added to the distributed machine learning system.

18. The apparatus as in claim 11, wherein the apparatus performs the machine learning task by:
receiving input data via a first one of the set of processing groups;
using the input data in conjunction with the portion of the machine learning model to generate output data; and
sending the output data via a second one of the set of processing groups.

19. The apparatus as in claim 11, wherein the machine learning task comprises making an inference using the portion of the machine learning model.

20. A tangible, non-transitory, computer-readable medium storing program instructions that cause a device to execute a process comprising:
maintaining, by the device, a set of processing groups of which the device is a member in a distributed machine learning system;
performing, by the device, a machine learning task with respect to a portion of a machine learning model distributed across the distributed machine learning system;
receiving, at the device, an indication of a change in the distributed machine learning system; and
adjusting, by the device and based on the indication, the set of processing groups of which the device is a member in the distributed machine learning system.
